(19) United States
(12) Patent Application Publication
(10) Pub. No.: US 2026/0050494 A1
(43) Pub. Date: Feb. 19, 2026

(54) METHOD, DEVICE AND STORAGE MEDIUM FOR FUNCTION INVOCATION

(71) Applicant: Beijing Zitiao Network Technology Co., Ltd., Beijing (CN)

(72) Inventors: Xiaying ZHOU, Beijing (CN); Yiyu HE, Beijing (CN); Tianhao WU, Beijing (CN); Zhibin FANG, Beijing (CN); Tao XI, Beijing (CN); Zilong ZHOU, Beijing (CN); Lizi ZHAO, Beijing (CN)

(21) Appl. No.: 19/302,673

(22) Filed: Aug. 18, 2025

(30) Foreign Application Priority Data
Aug. 18, 2024 (CN) 202411133011.7

(51) Int. Cl. G06F 9/54

(52) U.S. Cl. CPC G06F 9/54

(57) ABSTRACT

Embodiments of the disclosure provide a method, apparatus, device and storage medium for function invocation. The method includes: determining, in response to invocation of a first function being triggered, at least one invocation parameter of the first function based on configuration information of the first function; obtaining a parameter value of the at least one invocation parameter based on a trigger mode of the invocation, the trigger mode being one of a plurality of predetermined modes for triggering invocation of the first function; and invoking the first function based on the parameter value of the at least one invocation parameter. In this way, the function is enabled to support invocation through different trigger modes, thereby meeting different usage requirements.

### CROSS-REFERENCE

This application claims the benefit of Chinese Patent Application No. 202411133011.7 filed on Aug. 18, 2024, entitled “METHOD, DEVICE, APPARATUS AND STORAGE MEDIUM FOR FUNCTION INVOCATION”, which is hereby incorporated by reference in its entirety.

### FIELD

Example embodiments of the present disclosure generally relate to the field of computers, and in particular, to methods, devices, and computer-readable storage medium for function invocation.

### BACKGROUND

With the development of information technologies, various terminal devices may provide various services to people in terms of work and life. An application providing a service may be deployed in the terminal device. The terminal device presents corresponding content through a user interface of the application, realizes interaction with the user, and meets various requirements of the user. In some cases, a user may initiate a function invocation request within an application. Therefore, how to improve function invocation efficiency is a concern.

### SUMMARY

In a first aspect of the present disclosure, a method for function invocation is provided. The method comprises: determining, in response to invocation of a first function being triggered, at least one invocation parameter of the first function based on configuration information of the first function; obtaining a parameter value of the at least one invocation parameter based on a trigger mode of the invocation, the trigger mode being one of a plurality of predetermined modes for triggering invocation of the first function; and invoking the first function based on the parameter value of the at least one invocation parameter.

In a second aspect of the present disclosure, an apparatus for function invocation is provided. The apparatus comprises: a determining module, configured to determine, in response to invocation of a first function being triggered, at least one invocation parameter of the first function based on configuration information of the first function; an obtaining module, configured to obtain a parameter value of the at least one invocation parameter based on a trigger mode of the invocation, the trigger mode being one of a plurality of predetermined modes for triggering invocation of the first function; and an invoking module, configured to invoke the first function based on the parameter value of the at least one invocation parameter.

In a third aspect of the present disclosure, an electronic device is provided. The electronic device includes at least one processor; and at least one memory coupled to the at least one processor and storing instructions for execution by the at least one processor that, when executed by the at least one processor, causing the electronic device to perform the method according to the first aspect of the present disclosure.

In a fourth aspect of the present disclosure, a computer-readable storage medium is provided. The computer-readable storage medium stores a computer program, and the computer program when is executed by a processor implements the method according to the first aspect of the present disclosure.

According to a fifth aspect of the present disclosure, there is provided a computer program product, comprising a computer program, wherein the computer program, when executed by a processor, implements the method according to the first aspect of the present disclosure.

It should be appreciated that the content described in this section is not intended to limit the key features or important features of the embodiments of the present disclosure, nor is it intended to limit the scope of the present disclosure. Other features of the present disclosure will become readily appreciated from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 shows a flowchart of a process for function invocation according to some embodiments of the present disclosure;

FIG. 3 illustrates a schematic diagram of an example of a configuration interface according to some embodiments of the present disclosure;

FIG. 4A and FIG. 4B show a flowchart of a signaling flow for function invocation according to some embodiments of the present disclosure respectively;

FIG. 5 illustrates a schematic diagram of an example of an invocation relationship construction interface according to some embodiments of the present disclosure;

FIG. 6 shows a flowchart of a signaling flow for function invocation according to some embodiments of the present disclosure;

FIG. 7 shows a schematic structural block diagram of an apparatus for function invocation according to some embodiments of the present disclosure; and

FIG. 8 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “including” and the like should be understood to include “including but not limited to”. The term “based on” should be understood as “based at least in part on”. The terms “an embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performs one step and does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It may be understood that before using the technical solutions disclosed in the embodiments of the present disclosure, a relevant user should be informed of the types, use ranges, usage scenarios, and the like of the information related to the present disclosure in an appropriate manner according to relevant laws and regulations, and the authorization of the related users may be obtained, wherein the relevant user may include any type of rights body, such as an individual, an enterprise, and a group.

For example, when a proactive request of a user is received, prompt information is sent to the related user to explicitly prompt the related user that the operation requested to be performed will need to obtain and use the information of the related user, so that the related user can autonomously select whether to provide information to software or hardware (such as an electronic device, an application, a server or a storage medium) executing the operation of the technical solution of the present disclosure according to the prompt information.

As an optional but non-limiting implementation, in response to receiving a proactive request of a related user, a manner of sending prompt information to the related user may be, for example, a pop-up window, and prompt information may be presented in a text manner in the pop-up window. In addition, the pop-up window may further carry a selection control for the user to select “agree” or “not agree” to provide information to the electronic device.

It may be understood that the foregoing process of notification and obtaining user authorization is merely illustrative, and does not constitute a limitation on implementations of the present disclosure, and other manners of meeting related laws and regulations may also be applied to implementations of the present disclosure. According to the method for enabling the digital assistant related function, the acquired data, the data processing and storage mode and the like, should be authorized in advance by the user and other right bodies associated with the user, and the agreement of the related laws and regulations and the right body protocol rules should be met.

As used herein, the term “model” may learn from training data an association relationship between respective inputs and outputs such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is an example of a deep learning-based model. As used herein, a “model” may also be referred to as a “machine learning model,” a “learning model,” a “machine learning network,” or a “learning network,” which terms are used interchangeably herein.

As used herein, the term “function” should be understood to refer to a functional module that has a particular capability, is capable of performing a particular task, and/or is capable of providing a particular service. For example, the “function” may have the ability to invoke a model to generate particular content, or the “function” may have the ability to perform a particular task alone.

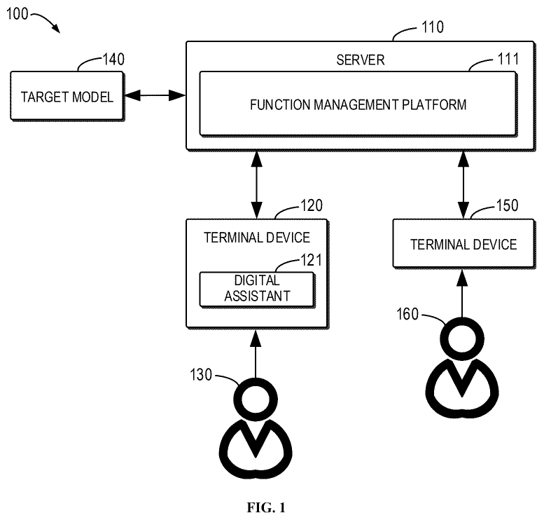

FIG. 1 illustrates a schematic diagram of an example environment 100 in which embodiments of the present disclosure can be implemented. The environment 100 involves a server 110, terminal devices 120, 150, and a target model 140.

As shown in FIG. 1, the server 110 is deployed with a function management platform 111, which may include a function creation part and a function application part. The function creation part may provide a creation, publishing and management environment of functions for the user 160. In some embodiments, the function management platform 111 may be a low code platform that provides a tool collection of functionality creation.

The function management platform 110 may support visualization development of functions. The function management platform 111 may support any suitable platform for a user to develop functions.

The function management platform 111 may be deployed at the server 110, or may be deployed locally on the terminal device 120 of the user 130, and/or may be supported by a remote server. For example, the terminal device 120 of the user 130 may run a client of the function management platform 111, and the client may support interaction between the user 130 and the function management platform 111. When the function management platform runs on the terminal device 120 of the user 130, the user 130 may directly interact with the local function management platform by using the client. When the function management platform 111 runs at the server 110, the server 110 may implement, based on the communication connection with the terminal device 120, provision of the service of the client running in the terminal device 120.

The terminal device 120 may be deployed with a digital assistant 121, and the user 130 may interact with the digital assistant 121 by using the terminal device 120 or an attached device of the terminal device 120. The digital assistant 121 is provided to assist the user 130 in various task processing requirements in different applications and scenarios. The digital assistant 121 typically has capabilities of intelligent dialog and task processing. During interaction with the digital assistant 121, the user 130 enters an interactive message (e.g., text, voice, image, video, or dialog content of other modalities), and the digital assistant 121 provides a reply message in response to the user input. Generally, the digital assistant 121 can support the user 130 to enter questions in a natural language manner and can perform tasks and providing replies based on capabilities of understanding natural language inputs and logical reasoning. The digital assistant 121 may also be configured to invoke a matching interface to provide a reply message according to the user input, thereby improving the processing power of the digital assistant 121.

In embodiments of the present disclosure, the user 160 may create a function according to a requirement on the function creation part of the function management platform 111, and publish the function. The function may be published to any appropriate function application part as long as the function application part can support the invocation of functions by the digital assistant 121. The function application part may be deployed at the server 110, or may be deployed at the terminal device 120 of the user 130. Upon publish of a function, the digital assistant 121 may invoke the function to provide services to the user 130. For example, the user 130 may enter a chat message in a chat window of the digital assistant 121. The digital assistant 121 may request the function management platform 111 to assist in invoking the function and obtain feedback information from the function, determine a reply message based on the feedback information, and present the reply message to the user in the chat window.

In some embodiments, the digital assistant 121 may utilize the target model 140 to support interaction with the user 130. For example, the digital assistant 121 may utilize one or more target models to provide a question-and-answer service to the user 130.

In some embodiments, the one or more target models 140 may be constructed based on a language model (LM). The machine learning model used is a content generative model capable of generating corresponding outputs based on model inputs. In some embodiments, the machine learning model based on the language model can process a model input (e.g., natural language and/or machine language) of the text modality and/or a model input (e.g., image, voice, video, etc.) of the non-text modality, and can generate the desired output from the model input and a prompt. The prompt herein is used to guide generation of the machine learning model to address the user requirement indicated by the model input. In an application scenario for supporting a user dialog, the user input may be provided to the machine learning model as at least a portion of the model input (other portions may include the prompt). This user input is considered as a question. Based on the model output, a corresponding reply may be generated and provided to the user 130.

The function management platform 111 may run on a suitable electronic device. The electronic device herein may be a device of any type having a computing capability, including a terminal device or a server device. The terminal device may be a mobile terminal, fixed terminal, or portable terminal of any type, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, including accessories and peripherals of these devices, or any combination thereof. The server 110 may include, for example, a computing system/server, such as a mainframe, an edge computing node, a computing device in a cloud environment, or the like. In some embodiments, the function management platform 111 may be implemented based on cloud services.

It should be understood that the structures and functions of the various elements in the environment 100 are described for illustrative purposes only and do not imply any limitation to the scope of the present disclosure.

As mentioned above, the terminal device may be deployed with an application or a digital assistant that provides a service, and may initiate a function invocation through the application or the digital assistant. With the development of information technologies, the application of functions has become more and more diversified. In order to meet the use requirements of the same function in different application scenarios, it is expected that the same function can be invoked by using multiple invocation approaches. However, invocation logic and acquisition of invocation parameters for different invocation approaches are usually different. Traditionally, functions are usually built for a specific invocation approach, and it is usually difficult to meet the use requirements of invocation by using multiple invocation methods.

In view of the above, embodiments of the present disclosure provide an improved solution for function invocation. In this solution, in response to invocation of a target function being triggered, at least one invocation parameter of the target function is determined based on configuration information of the target function. A parameter value of at least one invocation parameter is obtained based on a trigger mode by which the target function is invoked. The trigger mode is one of a plurality of predetermined modes for triggering an invocation of the target function. The target function is invoked based on the parameter value of the at least one invocation parameter.

In embodiments of the present disclosure, at least one invocation parameter required to invoke a function is specified in the configuration information. In use, the parameter value of the at least one invocation parameter is obtained according to a trigger mode for triggering the invocation of the function. This enables the function to support the use requirement of triggering the invocation by using different trigger modes, which is beneficial to extend the application scenario of the function.

Some example embodiments of the present disclosure will be described in detail below with reference to examples of the accompanying drawings.

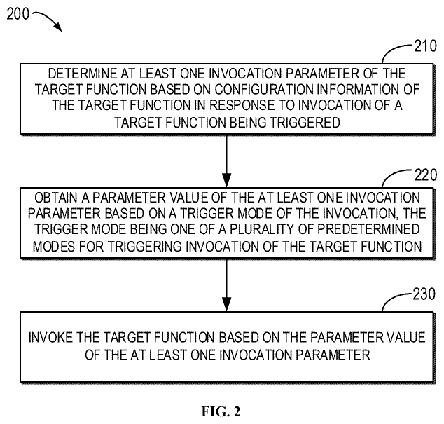

FIG. 2 shows a flowchart of a process 200 for function invocation according to some embodiments of the present disclosure. The process 200 may be implemented at the server 110, for example, may be implemented by a function application part of the function management platform 110 deployed at the server 110. The process 200 shown in FIG. 2 is described below with reference to FIG. 1.

At block 210, the server 110 determines at least one invocation parameter of the target function based on configuration information of the target function in response to invocation of a target function being triggered. The functions herein may include functional modules having different capabilities, and the target function may include, but are not limited to, a content generation function, a data analysis function, a data processing function, and the like, that utilize a language model. The task performed by the function, the capability provided by the function, or the service provided by the function is not limited herein. The at least one invocation parameter may include one or more parameters required to perform an invocation operation on the target function. The at least one invocation parameter may include one invocation parameter or a plurality of invocation parameters.

It may be understood that the at least one invocation parameter corresponds to the function. For different functions, specific parameters included in the at least one invocation parameter may be different. For example, the target function may be used to generate network promotion content, and the at least one invocation parameter of the target function may include a title and a promotion channel. For another example, the target function may be used to query weather, and the at least one invocation parameter of the target function may include a time and a place.

During creation of the target function, the at least one invocation parameter of the target function may be configured, and the at least one invocation parameter may be stored in, for example, a data storage unit of the server 110 as at least a portion of the configuration information. In some embodiments, the server 110 may present a configuration interface of the target function in response to a configuration request for the target function. Afterwards, the server 110 may receive attribute information of the at least one invocation parameter through the configuration interface. The attribute information herein is used to describe a basic attribute of an invocation parameter, and the attribute information may include, but is not limited to, a parameter name, a type, a description, and the like of the invocation parameter.

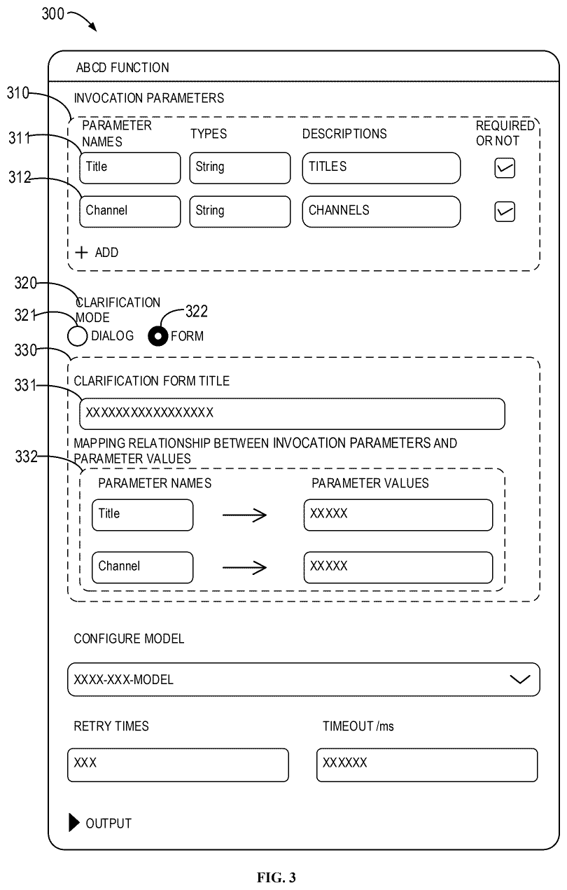

An example is described with reference to FIG. 3. FIG. 3 illustrates a schematic diagram of an example 300 of the configuration interface according to some embodiments of the present disclosure. Example 300 illustrates a configuration interface of an “ABCD function” that may be used to generate marketing materials for a specified commodity distribution channel. The example 300 includes an invocation parameter input entry 310, and the invocation parameter input entry 310 may include at least one group of input boxes in a one-to-one correspondence with the at least one invocation parameter. Specifically, the at least one invocation parameter may include a “title” of the marketing material and a distribution “channel” to which the marketing material is directed. In this case, the at least one group of input boxes may include a group of input boxes 311 corresponding to the “title” and a group of input boxes 312 corresponding to the “channel”. The group of input boxes 311 and the group of input boxes 312 include input boxes for entering a parameter name, type, and description, respectively. The user may enter the attribute information of the at least one invocation parameter to the invocation parameter input entry 310. Certainly, the foregoing configuration interface is merely an example, and in practice, the interface element and the interface layout included in the configuration interface may be selected according to actual needs.

In some embodiments, the server 110 may further include a data storage unit for storing metadata of a function. After determining the invoked target function, the function management platform 111 may send an information obtaining request to the data storage unit based on a function identifier of the target function. The function metadata storage unit may feed configuration information of the target function back to the function management platform in response to the information obtaining request. The configuration information may include at least one invocation parameter of the target function. The at least one invocation parameter is used to perform an invocation operation on the target function.

At block 220, the server 110 obtains a parameter value of the at least one invocation parameter based on a trigger mode of the invocation. The target function herein may be configured to be capable of being triggered by a plurality of predetermined modes, and the trigger mode is one of a plurality of predetermined modes for triggering invocation of the target function. Alternatively, or additionally, the plurality of predetermined modes may have corresponding obtaining manners for a plurality of parameter values. If the trigger mode of the invocation is determined, the parameter value of the at least one invocation parameter may be obtained in a corresponding obtaining manner.

The process of obtaining the parameter value in different trigger modes by the server 110 will be exemplarily described below in combination with some specific trigger modes, but it should not be understood that the target function is limited to only the trigger modes shown below, nor should be understood that the parameter value of the invocation parameter may be obtained only in the following obtaining manners in each trigger mode shown below.

In some embodiments, the target function may be configured to be triggered by a chat trigger mode. Specifically, the server 110 may determine a function matching a user input from the at least one function in response to receiving the user input. If it is determined that the function matches the user input, it is determined that the trigger mode is the chat trigger mode, and the invocation to the target function is triggered based on the chat trigger mode. Afterwards, the server 110 may obtain the configuration information of the target function in response to triggering the invocation of the target function through the chat mode. A clarification mode of the at least one invocation parameter is determined based on the configuration information, and a parameter value of the at least one invocation parameter is obtained based on the clarification mode. Alternatively, or additionally, the clarification mode may include, but is not limited to, a dialog mode, a form mode, and the like. The dialog mode and the form mode will be described in detail below with respect to specific example, and thus will not be described in detail here.

During creation of the target function, the clarification mode of the at least one invocation parameter of the target function may be configured. In some embodiments, the server 110 may receive, through the configuration interface, a selection of the clarification mode of the at least one invocation parameter, and the clarification mode indicates an obtaining manner of the at least one invocation parameter.

For example, as shown in FIG. 3, the configuration interface shown in the example 300 may further include a mode selection entry 320, and the mode selection entry 320 may include one or more option boxes in a one-to-one correspondence with predetermined one or more clarification modes. In the example 300, the option box 321 corresponding to the dialog mode and the option box 322 corresponding to the form mode are set respectively. In response to a selection operation by the user on the form mode, the server 110 may switch the option box 322 to a selection state (for example, switch a line of the option box to a bold line), and switch the option box 321 to an unselected state (for example, switch a line of the option box to a thin line).

Further, the configuration interface shown in the example 300 may further include a structure information input entry 330, which is used to receive structure information of a form, and the structure information of the form includes, but is not limited to, a title of the form, an invocation parameter of the form, and the like. The server 110 may present the structure information input entry 330 in the configuration interface in response to a selection of the option box 322 corresponding to the form mode, and the structure information input entry 330 may include a form title input entry 331 and an invocation parameter configuration entry 332. A user (e.g., a creator of a function) may enter a title for the form into the form title input entry. The invocation parameter configuration entry 332 may include a plurality of input boxes, for example, an input box for entering a parameter name of an invocation parameter, an input box for entering a parameter value, and an element for representing a mapping relationship between parameter names and parameter values, and the like. The user may configure an invocation parameter required for clarification through the invocation the parameter configuration entry 332.

In some embodiments, the server 110 may present a parameter input interface including a form based on structure information of the form in response to the configuration information indicating that the clarification mode of the at least one invocation parameter is the form mode. The form may include a parameter value input entry for the at least one invocation parameter. The server 110 may receive the parameter value of the at least one invocation parameter through the parameter value input entry. The parameter value input entry herein may be pre-filled with a parameter value for confirmation by the user, or may be set to a null value to wait for a user input. As an example, the server 110 may present a form similar to the structure information input entry 330 in the example 300, and the form may include, for example, a title, a parameter name, an input box for entering a parameter value, and an element for representing a mapping relationship between parameter names and parameter values, and the like.

It should be further noted that the parameter input interface is not limited to obtaining the parameter value of the at least one invocation parameter by using the data structure of the form, and the parameter value of the at least one invocation parameter may be obtained by using another data structure, provided that the parameter input interface includes the parameter value input entry of the at least one invocation parameter, and the parameter value of the at least one invocation parameter can be accepted by using the parameter value input entry.

In some embodiments, the server 140 may generate prompt information for the target model 140 based on the user input and the at least one invocation parameter, and the server 140 may provide the prompt information to the target model 140 to obtain an output of the target model 140. Then, the server 140 may determine the parameter value of at least a portion of the at least one invocation parameter based on the output of the target model 140.

As an example, the server 110 may further include a flow manager, a flow engine, and a business engine. The function management platform 111 of the server 110 may generate prompt information for the target model 140 based on the user input and at least one call parameter. The function management platform 111 sends the prompt information to the flow manager, the flow manager sends the prompt information to the flow engine, and the flow engine sends the prompt information to the business engine. Subsequently, in response to receiving the prompt information, the business engine may provide the prompt information to the target model 140. The business engine may further receive the output of the target model 140 and send the output of the target model 140 to the function management platform 111 through the flow engine and the flow manager. The function management platform 111 may determine the parameter value of at least a portion of the invocation parameters based on the output of the target model 140.

It may be understood that the user input may include parameter values of all invocation parameters, or may only include parameter values of a portion of the invocation parameters. For the case where the target model 140 determines the parameter values of a portion of the invocation parameters and the parameter values of other portions of the invocation parameters are lacking, in some embodiments, the server 110 may present structured content for the at least one invocation parameter in response to determining that a portion of the at least one invocation parameter lacks a parameter value. The structured content includes a parameter value determined based on the output of the target model 140 and a parameter value input entry for a portion of the invocation parameters. The parameter value for the portion of the invocation parameters is received through the parameter value input entry for the portion of the invocation parameters.

As an example, the server 110 may present a form similar to the structure information input entry 330 in the example 300. The form may include, for example, a title, parameter names, input boxes for entering parameter values, and elements for representing a mapping relationship between parameter names and parameter values, and the like. The server may fill the parameter value determined based on the output of the target model 140 into a corresponding parameter input entry in the form. For an invocation parameter of which the parameter value is not determined, the corresponding input box may be set as null, or for example, “please enter” may be presented in the corresponding input box. It should be noted that although the structured content is the form in the above example, it should not be understood that the structured content is limited to the form. The structured content herein may include various data content having a predetermined data format.

In some embodiments, the server 110 may perform a dialog operation with the terminal device 120 by using the target model 140 in response to the configuration information indicating that the clarification mode of the at least one invocation parameter is the chat mode, to obtain the parameter value of the at least one invocation parameter.

In some embodiments, the server 110 provides the prompt information generated based on the user input and the at least one invocation parameter to the target model 140 to obtain the output of the target model 140. The server 110 may obtain a clarification question for the at least one invocation parameter based on the output of the target model 140. In response to receiving a clarification response from the user to the clarification question, the server 110 may provide the prompt information generated based on the clarification response to the target model 140 to obtain the output of the target model 140. Then, the server 110 may determine the parameter value of the at least one invocation parameter based on the output of the target model 140.

For example, the server 110 may send the clarification question to the terminal device 120, and the terminal device 120 may present the clarification question. The user may enter the clarification response to the clarification question by the terminal device 120 or an attachment device of the terminal device 120. The terminal device 120 may feed the clarification response to the server 110 in response to receiving the clarification response. The server 110 may provide, to the target model 140, prompt information generated based on the clarification response, so as to extract the parameter value of the at least one invocation parameter from the clarification response by using the target model. In this way, the dialog capability and parameter extraction capability of the target model are utilized, so that the generation of the clarification question and the extraction of the parameter value are realized, and the processing logic is simplified.

In some embodiments, the server 110 may obtain a first clarification question for a first invocation parameter in the at least one invocation parameter based on the output of the target model 140. In response to receiving a first clarification response from the user to the first clarification question, the server 110 may provide, to the target model 140, prompt information based on the first clarification response to obtain the output of the target model 140. A parameter value of the first invocation parameter is determined based on the output of the target model 140. The first invocation parameter herein may include all or a portion of the parameters of the at least one invocation parameter.

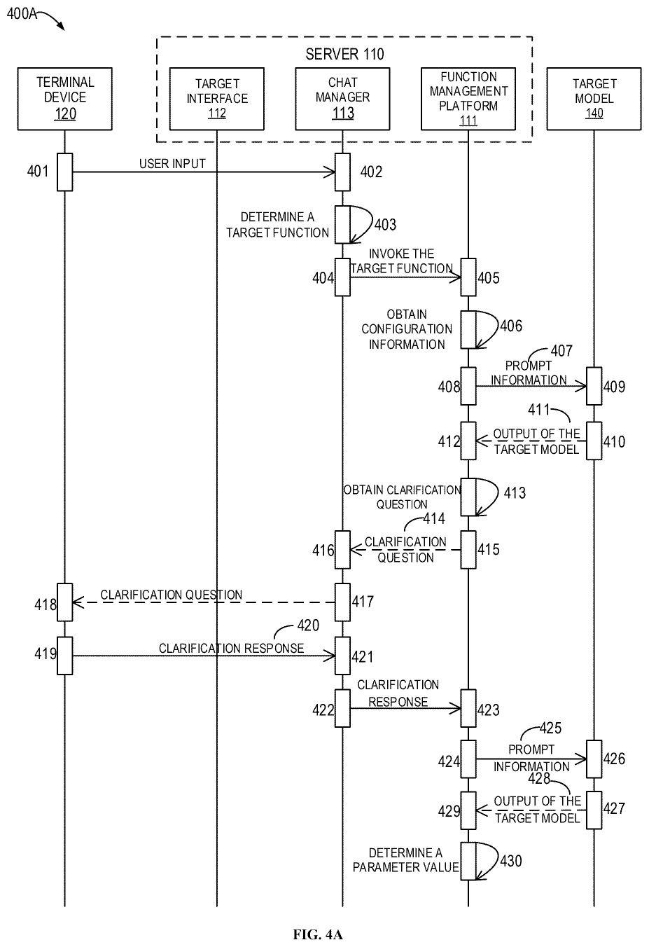

To illustrate that the target function is triggered by using the chat trigger mode, the process of triggering the target function by using the chat trigger mode is described in conjunction with FIG. 4A as an example. FIG. 4A illustrates a flowchart of a signaling flow 400A for function invocation in accordance with some embodiments of the present disclosure. The signaling flow 400A involves the terminal device 120, the server 110, and the target model 140. The server 110 includes a target interface 112, a dialog manager 113, and the function management platform 111. The function management platform 111 may pre-create at least one function.

As shown in the signaling flow 400A, the user 130 may enter the user input to the terminal device 120 by the terminal device 120 or the attachment device of the terminal device 120. The terminal device 120 sends (401) the user input to the dialog manager 113 in response to receiving the user input. Alternatively, or additionally, the user input may include multimodal content such as text, voice, picture, video, and the like. The dialog manager 113 receives (402) the user input from the terminal device 120. The dialog manager 113 determines (403) a target function that matches the user input from the pre-created at least one function in response to receiving the user input.

Regarding determination by the dialog manager 113 of the target function that matches the user input, in an example, the dialog manager 113 may generate prompt information based on the user input and description information of the at least one function, and provide the prompt information to the target model 140 or another model to obtain the output of the target model 140. The dialog manager 113 may determine a function that matches the user input based on the output of the target model 140. Of course, the dialog manager 113 is not limited to determining the function matching the user input by using the target model 140, and the dialog manager 113 may determine the function matching the user input based on, for example, semantic recognition or other manners.

As shown by the signaling flow 400A, the dialog manager 113 may trigger (404) invocation of the target function to the function management platform 111. The function management platform 111 may obtain (406) configuration information to respond (405) the invocation of the target function, and determine at least one invocation parameter of the target function based on the configuration information. The function management platform 111 generates prompt information 407 based on the user input and the at least one invocation parameter. The function management platform 111 may then provide (408) the prompt information 407 to the target model 140 through, for example, a flow manager, a flow engine, and a business engine. The target model 140 generates an output 411 of the target model in response to receiving (409) the prompt information 407. The target model 140 may feed (410) the output 411 to the function management platform 111 through, for example, the flow manager, the flow engine, and the business engine. The function management platform 111 obtains a clarification question 414 based on the output 411 in response to receiving (412) the output 411. The function management platform 111 may send (415) the clarification question 414 to the dialog manager 113, which in response to receiving (416) the clarification question 414, sends (417) the clarification question 414 to the terminal device 120.

As shown by the signaling flow 400A, the terminal device 120 may present the clarification question 414 in response to receiving the clarification question 414. The user may enter a clarification response 420 for the clarification question 414. The terminal device 120 sends (419) the clarification response 420 to the dialog manager 113 in response to receiving the clarification response 420. The dialog manager 113 sends (422) the clarification response 420 to the function management platform 111 in response to receiving (421) the clarification response 420. The function management platform 111 generates prompt information 425 based on the clarification response 420 in response to receiving (423) the clarification response 420. The function management platform 111 provides (425) the prompt information 425 to the target model 140, and the target model 140 receives (426) the prompt information 425, and generates an output 428 based on the prompt information 425. Then, the target model 140 may feedback (427) the output 428 to the function management platform 111, which in response to receiving (429) the output 428, determines (430) the parameter value for the at least one invocation parameter.

Due to the randomness of the user dialog, the parameter value for all the at least one invocation parameter may be obtained based on the first clarification response, or a parameter value of a portion of the at least one invocation parameter may be obtained. Given that, the server 110 may determine whether an invocation parameter of the at least one invocation parameter lacks a parameter value. If it is determined that a second invocation parameter of the at least one invocation parameter lacks a parameter value, the server 110 may generate prompt information based on the second invocation parameter, and provide the prompt information to the target model 140, to obtain the output of the target model 140. Based on the output of the target model 140, a second clarification question is determined for the second invocation parameter. In response to receiving a second clarification response from the user to the second clarification question, the server 110 may provide prompt information generated based on the second clarification response to the target model 140 to obtain the output of the target model 140. Then, the parameter value of the second invocation parameter is determined based on the output of the target model 140.

For example, as shown in FIG. 4B, FIG. 4B shows a flowchart of a signaling flow 400B for function invocation according to some embodiments of the present disclosure. The signaling flow 400B involves the terminal device 120, the server 110, and the target model 140, and the server 110 includes the target interface 112, the dialog manager 113, and the function management platform 111. The function management platform 111 may pre-create at least one function. The signaling flow 400B occurs after the signaling flow 400A. The signaling flow 400A and signaling flow 400B collectively constitute a complete signaling flow.

As shown by signaling flow 400B, the function management platform 111 may determine (431) whether the at least one invocation parameter comprises an invocation parameter that lacks a parameter value. If the invocation parameter that lacks the parameter value is determined, the prompt information 433 may be generated based on the invocation parameter that lacks the parameter value. Then, a process similar to the block 408 to the block 430 of the signaling flow 400A may be performed. Since the process of blocks 408 to the block 430 has been explained in the signaling flow 400A, and thus is not described in detail here, and reference may be made to the foregoing explanation. At block 455, the function management platform 111 again extracts a parameter value based on the output 453 of the target model 140. Then, the signaling flow 400B may return to block 431 again, to determine whether the at least one invocation parameter comprises an invocation parameter that lacks a parameter value, and if it is determined that the parameter value for all the at least one invocation parameter has been obtained, it may be determined that the operation of obtaining the parameter value is completed.

In some embodiments, the target function may be configured to be triggered with a task trigger mode. If the server 110 receives an invocation request for the target function from the target interface, the server 110 may determine, in response to the invocation request, that the trigger mode of the invocation is the task trigger mode, and trigger the invocation of the target function based on the task trigger mode. The task herein may include, but are not limited to, a task performed by an application, a task triggered by a link, a task triggered by a process flow, and the like. That is, during the application performing the task, the invocation request may be sent to the target interface of the server 110 to trigger the invocation of the target function. Alternatively, if the link is triggered, the invocation request may be sent to the target interface of the server 110. Alternatively, during the execution of the processing flow, an operation of sending the invocation request to the target interface may be triggered in response to a processing result of the previous processing node. OF course, the foregoing task is merely an example, and in actual applications, a task for which an invocation request is sent to the target interface may be selected according to actual needs.

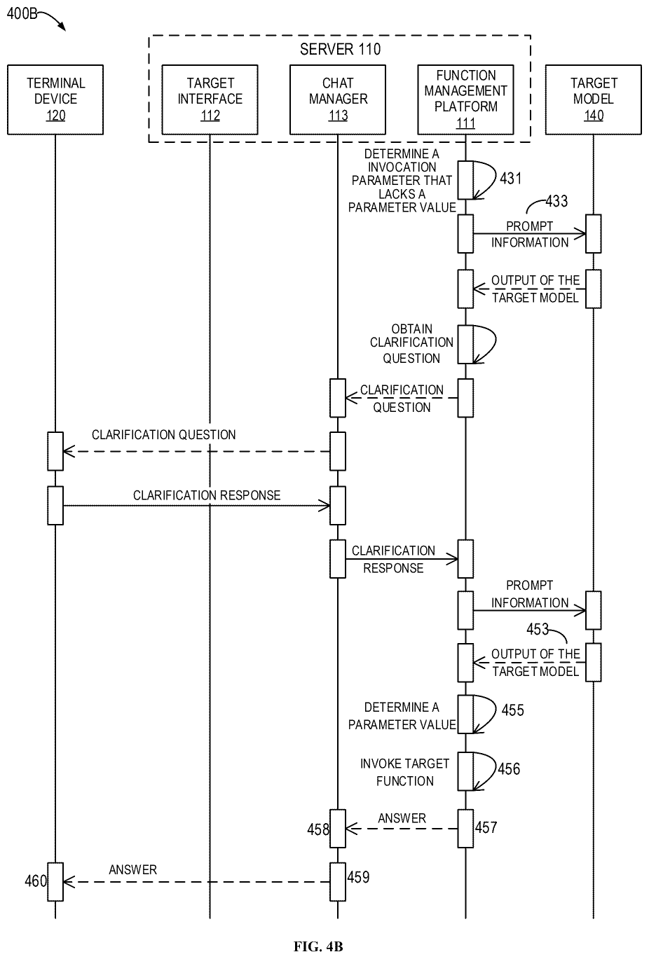

In some embodiments, an invocation relationship between the task and the target function may be pre-constructed, and the invocation of the target function may be triggered based on the invocation relationship in response to the execution of the task. For example, as shown in FIG. 5, FIG. 5 is a schematic diagram of an example 500 of an invocation relationship construction interface according to some embodiments of the present disclosure. The invocation relationship construction interface shown in the example 500 is configured to construct an invocation relationship between a processing node (for example, an XXX application) and a target function (for example, an ABCD function) of a target application. The example 500 includes an application input box 501, an operation input box 502, and a function input box 503. An application identifier (for example, an application name “XXX application”) of the target application may be entered through the application input box 501, a function identifier (for example, a function name “ABCD function” of the target function) of the target function may be entered through the function input box 503, and an invocation relationship (for example, an invocation function) between the target application and the target function may be entered through the operation input box 502. In this way, if the processing node corresponding to the example 500 is triggered in the execution process of the target application, an invocation request is sent to the target interface to trigger an invocation of the target function. Further, the example 500 may further include an incoming parameter configuration entry 504, which is used to configure an invocation parameter and a parameter value that are required to be provided for invocation of the target function by the target application. The incoming parameter configuration entry 504 may include a plurality of input boxes, such as output boxes for entering parameter names, types and parameter values. A user (e.g., a developer) may input a parameter name, a type, or the like of the invocation parameter to the incoming parameter configuration entry 504.

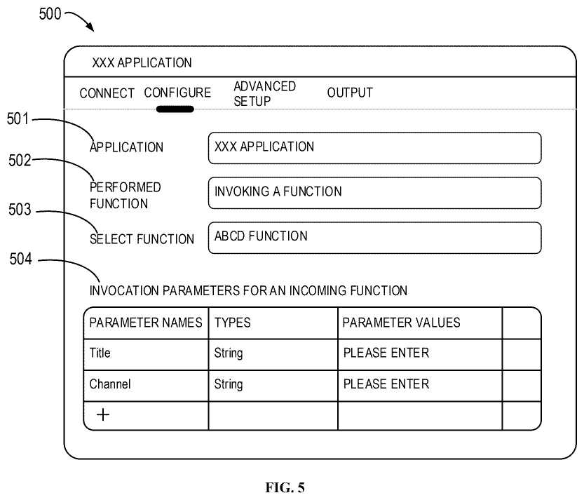

To illustrate that the target function is triggered by using the task trigger mode, the process of triggering the target function by using the task trigger mode is described in conjunction with FIG. 6 as an example. FIG. 6 shows a flowchart of a signaling flow 600 for function invocation according to some embodiments of the present disclosure. The signaling flow 600 involves the terminal device 120 and the server 110. The server 110 includes the target interface 112, the dialog manager 113, and the function management platform 111.

As shown in the signaling flow 600, the terminal device 120 may send (601) an invocation request for the target function to the target interface 112 of the server 110, and the target interface 112 receives the invocation request for the target function from the terminal device 120. For example, the terminal device 120 may run the target application, and the terminal device 120 may send to the target interface the invocation request for the target function in response to the target application triggering a predetermined processing node. For another example, the terminal device 120 may present an application interface, and the application interface may include a function trigger control. The terminal device 120 may send to the target interface the invocation operation on the target function in response to receiving a trigger on the function trigger control.

As shown by the signaling flow 600, the target interface 112 sends (603) the invocation request to the function management platform 111, which receives (604) the invocation request from the target interface. Then, the function management platform 111 may determine (605) a target function corresponding to the invocation request. For example, the function management platform 111 may determine a corresponding target function based on an interface number of the target interface 112. For another example, the invocation request may carry a function identifier (for example, a number used to identify a function) used to identify the target function, and the function management platform 111 may determine the corresponding target function based on the function identifier.

As shown by the signaling flow 600, the function management platform 111 may obtain (606) configuration information of the target function. For example, the function management platform 111 may send an information obtaining request to a data storage unit based on the function identifier, and receive the configuration information of the target function from the data storage unit. The function management platform 111 may determine at least one invocation parameter of the target function based on the configuration information.

Since the parameter value of the invocation parameter required to be transmitted for the invocation of the target function by the task has been pre-configured, the invocation request sent by the terminal device 120 may already carry the parameter value of the invocation parameter. Given that, the function management platform 111 may obtain (607) the parameter value of the at least one invocation parameter from the invocation request. If the parameter value for all the at least one invocation parameter cannot be obtained from the invocation request, the function management platform 111 may send notification information to the terminal device, to notify the terminal device 120 that the invocation of the target function fails.

At block 230, the server 110 invokes the target function based on the parameter value of the at least one invocation parameter. It may be understood that, in a case that the capability provided by the target function, the performed operation, or the provided service is different, the function management platform 111 may not have the same invocation mode for the target function based on the parameter value of the at least one invocation parameter.

As an example, if the target function needs to use the capability of the target model 140, the function management platform 111 may generate prompt information based on the at least one invocation parameter, and provide the prompt information to the target model 140 to obtain the output of the target model 140. Based on the output of the target model 140, an execution result of the target function is determined.

For example, the configuration information of the target function may include an invocation address of the target function. The function management platform 111 may invoke the target function based on the invocation address and the at least one invocation parameter. For example, the function management platform 11 may obtain weather information by invoking an interface.

In some embodiments, the server 110 may further determine the feedback information based on the trigger mode for the target function. For example, as shown in FIG. 4B, if the trigger mode is the chat trigger mode, the function management platform 111 may invoke (456) the target function to obtain an execution result of the target function. The function management platform 111 may determine a response to the user input based on the execution result of the target function. For example, the function management platform 111 may provide the execution result of the target function again to the target model 140, and generate a response to the user input by using the target model 140. The function management platform 111 may send (457) an answer to the dialog manager 113, which may send (459) the answer to the terminal device 120 in response to receiving (458) the answer. The terminal device 120 may present the answer in response to receiving (460) the answer.

For another example, as shown in FIG. 6, if the trigger mode is the task trigger mode, the function management platform may send (609) an execution result of the target function to the target interface 112. The target interface 112 may feed back (611) the execution result to the terminal device 120 in response to receiving (610) the execution result of the target function. After receiving (612) the execution result, the terminal device 120 may present the execution result, or may trigger another processing node.

In conclusion, according to the embodiments of the present disclosure, the parameter value of the at least one invocation parameter is obtained by specifying at least one invocation parameter required to invoke a function in the configuration information, and the parameter value of the at least one invocation parameter is obtained according to the trigger mode which specifically triggers the invocation of the function. In this way, the function can support the use requirement of triggering the invocation by using different trigger modes, which is beneficial to the application scenario of the extension function.

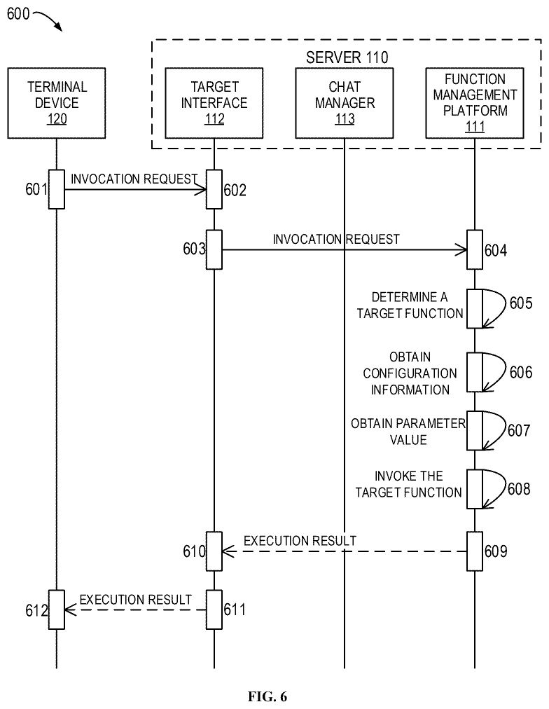

Embodiments of the present disclosure also provide a corresponding apparatus for implementing the above method or process. FIG. 7 is a schematic structural block diagram of an apparatus 700 for function invocation according to some embodiments of the present disclosure. The apparatus 700 may be implemented, for example, in or included in the server 110. The various modules/components in the apparatus 700 may be implemented by hardware, software, firmware, or any combination thereof.

As shown, the apparatus 700 includes a determining module 710, an obtaining module 720, and an invoking module 730. The determining module 710 is configured to determine at least one invocation parameter of a target function based on configuration information of the target function in response to invocation of the target function being triggered. The obtaining module 720 is configured to obtain a parameter value of the at least one invocation parameter based on a trigger mode of the invocation, the trigger mode being one of a plurality of predetermined modes for triggering invocation of the target function. The invoking module 730 is configured to invoke the target function based on the parameter value of the at least one invocation parameter.

In some embodiments, the determining module 710 is configured to determine the trigger mode by: in response to receiving the user input, determining a function matching a user input from the at least one function; and in response to determining that the target function matches the user input, determining that the trigger mode is a chat trigger mode.

In some embodiments, the obtaining module 720 is further configured to: present a parameter input interface based on the trigger mode being the chat trigger mode, the parameter input interface including a parameter value input entry for the at least one invocation parameter; and receive the parameter value of the at least one invocation parameter through the parameter value input entry.

In some embodiments, the configuration information indicates that a clarification mode of the at least one invocation parameter includes a form, and the configuration information includes structure information of the form; and the obtaining module 720 is further configured to: present a parameter input interface including the form based on the structure information of the form, the form including a parameter value input entry of the at least one invocation parameter.

In some embodiments, the obtaining module 720 is further configured to: provide, to a target model, prompt information generated based on the user input and the at least one invocation parameter to obtain an output of the target model; and determine the parameter value of at least a portion of the at least one invocation parameter based on the output of the target model.

In some embodiments, the obtaining module 720 is further configured to: present structured content for the at least one invocation parameter in response to determining that a portion of the at least one invocation parameter lacks a parameter value, the structured content including the parameter value determined based on the output of the target model and a parameter value input entry for the portion of the at least one invocation parameter; and receive the parameter value of the portion of the at least one invocation parameter through the parameter value input entry of the portion of the at least one invocation parameter.

In some embodiments, the configuration information indicates that a clarification mode of the at least one invocation parameter includes a dialog mode.

In some embodiments, the obtaining module 720 is further configured to: provide, to a target model, prompt information generated based on the user input and the at least one invocation parameter to obtain an output of the target model; obtain a clarification question for the at least one invocation parameter based on the output of the target model; provide, in response to receiving a clarification response from a user to the clarification question, prompt information generated based on the clarification response to the target model to obtain an output of the target model; and determine a parameter value of the at least one invocation parameter based on the output of the target model.

In some embodiments, the obtaining module 720 is further configured to: obtain a first clarification question for the first invocation parameter of the at least one invocation parameter based on the output of the target model; provide, in response to receiving a first clarification response from the user to the first clarification question, prompt information generated based on the first clarification response to the target model to obtain an output of the target model; and determine a parameter value of the first invocation parameter based on the output of the target model.

In some embodiments, the obtaining module 720 is further configured to: provide, in response to determining that the at least one invocation parameter comprises a second invocation parameter lacking a parameter value, prompt information generated based on the second invocation parameter to the target model to obtain an output of the target model; determine a second clarification question for the second invocation parameter based on the output of the target model; provide, in response to receiving a second clarification response from the user to the second clarification question, prompt information generated based on the second clarification response to the target model to obtain an output of the target model; and determine a parameter value of the second invocation parameter based on the output of the target model.

In some embodiments, the determining module 710 determines the trigger mode by: receiving an invocation request for the target function from a target interface; and determining, in response to the invocation request, that the trigger mode of the invocation is a task trigger mode.

In some embodiments, the obtaining module 720 is further configured to: obtain a parameter value of the at least one invocation parameter from the invocation request.

In some embodiments, the apparatus 700 further includes: a presentation module configured to: present, in response to a configuration request for the target function, a configuration interface of the target function; and receive, through the configuration interface, attribute information of the at least one invocation parameter.

In some embodiments, the apparatus 700 further includes: a receiving module configured to receive a selection of a clarification mode for the at least one invocation parameter through the configuration interface, the clarification mode indicating an obtaining manner for the at least one invocation parameter.

The units and/or modules included in the apparatus 700 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 700 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

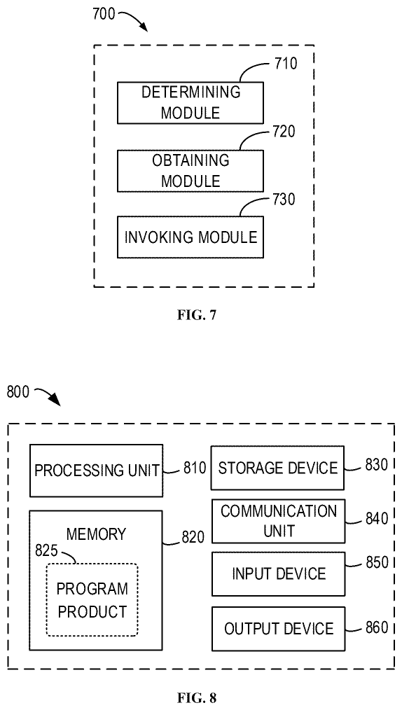

FIG. 8 illustrates a block diagram of an electronic device 800 in which one or more embodiments of the present disclosure may be implemented. It should be understood that the electronic device 800 illustrated in FIG. 8 is merely as an example and should not constitute any limitation on the function and scope of the embodiments described herein. The electronic device 800 shown in FIG. 8 may include or be implemented as the server 110 of FIG. 1 or the apparatus 700 of FIG. 7.

As shown in FIG. 8, the electronic device 800 is in the form of a general-purpose electronic device.

Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and capable of performing various processes according to programs stored in the memory 820. In multiprocessor systems, multiple processing units execute computer-executable instructions in parallel to improve parallel processing capabilities of electronic device 800.

The electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium, such as a flash drive, magnetic disk, or any other medium, which may be capable of storing information and/or data and may be accessed within the electronic device 800.

The electronic device 800 may further include additional removable/non-removable, volatile/non-volatile storage media. Although not shown in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 820 may include a computer program product 825 having one or more program modules configured to perform various methods or actions of various embodiments of the present disclosure.

The communication unit 840 is configured to communicate with another electronic device through a communication medium. Additionally, the function of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like.

The electronic device 800 may also communicate with one or more external devices (not shown) through the communication unit 840 as needed, external devices such as storage devices, display devices, etc., communicate with one or more devices that enable a user to interact with the electronic device 800, or communicate with any device (e.g., a network card, a modem, etc.) that enables the electronic device 800 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible embodiments of systems, methods, and computer program products according to various embodiments of the present disclosure. In this regard, each block in the flowchart or block diagram may represent a module, program segment, or portion of an instruction that includes one or more executable instructions for implementing the specified logical function. In some alternative embodiments, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the embodiments disclosed. Many modifications and variations will be apparent to those of ordinary skill in the art without departing from the scope and spirit of the various embodiments illustrated. The selection of the terms used herein is intended to best explain the principles of the embodiments, practical applications, or improvements to techniques in the marketplace, or to enable others of ordinary skill in the art to understand the various embodiments disclosed herein.

1. A method for function invocation, comprising:
determining, in response to invocation of a first function being triggered, at least one invocation parameter of the first function based on configuration information of the first function;
obtaining a parameter value of the at least one invocation parameter based on a trigger mode of the invocation, the trigger mode being one of a plurality of predetermined modes for triggering invocation of the first function; and
invoking the first function based on the parameter value of the at least one invocation parameter.

2. The method of claim 1, wherein the trigger mode is determined by:
determining, in response to receiving the user input, a function matching a user input from at least one function; and
determining that the trigger mode is a chat trigger mode in response to determining that the first function matches the user input.

3. The method of claim 2, wherein obtaining the parameter value of the at least one invocation parameter comprises:
presenting a parameter input interface based on the trigger mode being the chat trigger mode, the parameter input interface comprising a parameter value input entry for the at least one invocation parameter; and
receiving the parameter value of the at least one invocation parameter through the parameter value input entry.

4. The method of claim 3, wherein the configuration information indicates that a clarification mode of the at least one invocation parameter comprises a form, the configuration information comprises structure information of the form; and
wherein presenting the parameter input interface comprises:
presenting a parameter input interface comprising the form based on the structure information of the form, the form comprising a parameter value input entry of the at least one invocation parameter.

5. The method of claim 2, wherein obtaining the parameter value of the at least one invocation parameter comprises:
providing, to a first model, prompt information generated based on the user input and the at least one invocation parameter to obtain an output of the first model; and
determining the parameter value of at least a portion of the at least one invocation parameter based on the output of the first model.

6. The method of claim 5, wherein obtaining the parameter value of the at least one invocation parameter further comprises:
presenting structured content for the at least one invocation parameter in response to determining that a portion of the at least one invocation parameter lacks a parameter value, the structured content comprising the parameter value determined based on the output of the first model and a parameter value input entry for the portion of the at least one invocation parameter; and
receiving the parameter value of the portion of the at least one invocation parameter through the parameter value input entry of the portion of the at least one invocation parameter.

7. The method of claim 2, wherein the configuration information indicates that a clarification mode of the at least one invocation parameter comprises a dialog mode.

8. The method of claim 7, wherein obtaining the parameter value of the at least one invocation parameter comprises:
providing, to a first model, prompt information generated based on the user input and the at least one invocation parameter to obtain an output of the first model;
obtaining a clarification question for the at least one invocation parameter based on the output of the first model;
providing, in response to receiving a clarification response from a user to the clarification question, prompt information generated based on the clarification response to the first model to obtain an output of the first model; and
determining a parameter value of the at least one invocation parameter based on the output of the first model.

9. The method of claim 7, wherein obtaining the clarification question for the at least one invocation parameter comprises:
obtaining a first clarification question for a first invocation parameter of the at least one invocation parameter based on the output of the first model; and
determining the parameter value of the at least one invocation parameter comprises:
providing, in response to receiving a first clarification response from the user to the first clarification question, prompt information generated based on the first clarification response to the first model to obtain an output of the first model; and
determining a parameter value of the first invocation parameter based on the output of the first model.

10. The method of claim 9, wherein obtaining a clarification question for the at least one invocation parameter further comprises:
providing, in response to determining that the at least one invocation parameter comprises a second invocation parameter lacking a parameter value, prompt information generated based on the second invocation parameter to the first model to obtain an output of the first model;
determining a second clarification question for the second invocation parameter based on the output of the first model;
providing, in response to receiving a second clarification response from the user to the second clarification question, prompt information generated based on the second clarification response to the first model to obtain an output of the first model; and
determining a parameter value of the second invocation parameter based on the output of the first model.

11. The method of claim 1, wherein the trigger mode is determined by:
receiving an invocation request for the first function from a first interface; and
determining, in response to the invocation request, that the trigger mode of the invocation is a task trigger mode.

12. The method of claim 11, wherein obtaining the parameter value of the at least one invocation parameter comprises:
obtaining a parameter value of the at least one invocation parameter from the invocation request.

13. The method of claim 1, further comprising:
presenting a configuration interface of the first function in response to a configuration request for the first function; and
receiving attribute information of the at least one invocation parameter through the configuration interface.

14. The method of claim 13, further comprising:
receiving a selection of a clarification mode for the at least one invocation parameter through the configuration interface, the clarification mode indicating an obtaining manner for the at least one invocation parameter.

15. An electronic device, comprising:
at least one processor; and
at least one memory coupled to the at least one processor and storing instructions for execution by the at least one processor, the instructions, when executed by the at least one processor, causing the electronic device to perform acts comprising:
determining, in response to invocation of a first function being triggered, at least one invocation parameter of the first function based on configuration information of the first function;
obtaining a parameter value of the at least one invocation parameter based on a trigger mode of the invocation, the trigger mode being one of a plurality of predetermined modes for triggering invocation of the first function; and
invoking the first function based on the parameter value of the at least one invocation parameter.

16. The device of claim 15, wherein the trigger mode is determined by:
determining, in response to receiving the user input, a function matching a user input from at least one function; and
determining that the trigger mode is a chat trigger mode in response to determining that the first function matches the user input.

17. The device of claim 16, wherein obtaining the parameter value of the at least one invocation parameter comprises:
presenting a parameter input interface based on the trigger mode being the chat trigger mode, the parameter input interface comprising a parameter value input entry for the at least one invocation parameter; and
receiving the parameter value of the at least one invocation parameter through the parameter value input entry.

18. The device of claim 17, wherein the configuration information indicates that a clarification mode of the at least one invocation parameter comprises a form, the configuration information comprises structure information of the form; and
wherein presenting the parameter input interface comprises:
presenting a parameter input interface comprising the form based on the structure information of the form, the form comprising a parameter value input entry of the at least one invocation parameter.

19. The device of claim 16, wherein obtaining the parameter value of the at least one invocation parameter comprises:
providing, to a first model, prompt information generated based on the user input and the at least one invocation parameter to obtain an output of the first model; and
determining the parameter value of at least a portion of the at least one invocation parameter based on the output of the first model.

20. A non-transitory computer-readable storage medium having a computer program stored thereon, wherein the computer program is executable by a processor to implement acts comprising:
determining, in response to invocation of a first function being triggered, at least one invocation parameter of the first function based on configuration information of the first function;
obtaining a parameter value of the at least one invocation parameter based on a trigger mode of the invocation, the trigger mode being one of a plurality of predetermined modes for triggering invocation of the first function; and
invoking the first function based on the parameter value of the at least one invocation parameter.
